(19) United States
(12) Patent Application Publication
(10) Pub. No.: US 2016/0179768 A1
(43) Pub. Date: Jun. 23, 2016

(54) MULTICHANNEL AUTHORING AND CONTENT MANAGEMENT SYSTEM

(71) Applicant: Constant Contact, Waltham, MA (US)

(72) Inventors: Stefan PIESCHE, Clinton, MA (US); John STAUFFER, Framingham, MA (US); Eric BELAND, Natick, MA (US)

(21) Appl. No.: 14/580,757

(22) Filed: Dec. 23, 2014

(51) Int. Cl. G06F 17/22; G06F 3/0484; G06F 17/21; G06F 17/24

(52) U.S. Cl. CPC G06F 17/2247; G06F 17/2276; G06F 17/24; G06F 3/0484; G06F 17/218

(57) ABSTRACT

The present disclosure relates to systems, apparatus and methods for implementing a multichannel authoring and content management system. The content management system can classify stored documents into different “layout” types (e.g., “article”, “email”, or “coupon”), and also identify and classify discrete elements within each document according to different “element types” (e.g., “title”, “description”, “date”, or “image”). The content management system can also store documents according to multiple different digital formats. Storing documents in different formats, as well as metadata identifying each document's layout and element types, can facilitate retrieval of old content for the purpose of repackaging into new content. In particular, using multiple formats and identifying metadata can facilitate the content repackaging process by increasing the effectiveness of automated computer processes and decreasing the amount of human intervention required. The content management system can therefore be useful for applications which require a high rate of content re-use.

### FIELD OF THE DISCLOSURE

The present disclosure relates generally to systems and methods for creating, editing, organizing, storing, retrieving, and publishing content, such as documents, pictures and other data.

### BACKGROUND

Content management systems organize and store content for later retrieval. In the publishing and advertising industries, content management systems are generally used to store advertising or marketing-related “content,” such as previously authored and/or published articles, webpages, emails, coupons, newsletters, and/or banner ads.

Content management systems can be especially useful for publishing and advertising organizations that repackage old content when creating new content. For example, an ad agency, in-house advertising department, or other organization could have previously generated a flyer advertising a certain product or service for distribution in a physical mail campaign. When the organization wishes to generate an email campaign advertising the same product or service, the organization may retrieve the content generated for the previous mail campaign and re-package the content for use in the new email campaign. By repackaging the content instead of redesigning content from scratch, the organization saves time and costs. Also, by repackaging old content when creating new content, the organization ensures consistency in messaging and format across different channels, e.g., physical mail and email. Alternatively, the organization can use the old content as a template when creating a new campaign (physical mail or email) advertising a similar (but not identical) product or service.

### BRIEF DESCRIPTION OF THE DRAWINGS

Various objects, features, and advantages of the present disclosure can be more fully appreciated with reference to the following detailed description when considered in connection with the following drawings, in which like reference numerals identify like elements. The following drawings are for the purpose of illustration only and are not intended to be limiting of the invention, the scope of which is set forth in the claims that follow.

FIG. 1 is a system block diagram illustrating the components of a content management system, in accordance with some embodiments.

FIG. 2A is an exemplary, non-exhaustive list of element types that can be tracked and distinguished by the content management system, in accordance with some embodiments.

FIG. 2B is an exemplary, non-exhaustive list of layout types that can be tracked and distinguished by the content management system, as well as an exemplary set of associations between each exemplary layout type and element types, in accordance with some embodiments.

FIG. 3 is an conceptual block diagram that illustrates CMS storage 110 and its contents in greater detail, according to some embodiments.

FIG. 4 is a schematic of an exemplary document of the layout type “coupon,” in accordance with some embodiments.

FIG. 5 is a flowchart illustrating an exemplary process for creating new content using a content editor associated with the content management system, in accordance with some embodiments.

FIG. 6 is an exemplary screenshot of a content editor for creating new content, according to some embodiments.

FIG. 7 is a flowchart illustrating an exemplary process for analyzing and inferring layout types and element types for content received from other content editors, in accordance with some embodiments.

FIG. 8 is a flowchart illustrating an exemplary process for retrieving content saved by the content management system, in accordance with some embodiments.

FIG. 9 is an exemplary logical diagram that illustrates how a previously authored document (e.g., a HTML5 formatted website coupon) stored in a content management system can be repackaged into new content adapted for different delivery channels (e.g., a website banner ad, a SMS ad, and/or a postcard), in accordance with some embodiments.

FIGS. 10A and 10B are flowcharts depicting exemplary processes for saving content into CMS 100, and for repackaging the saved content into new content (e.g., a banner ad in HTML3 format), respectively, in accordance with some embodiments.

### DESCRIPTION OF EXAMPLE EMBODIMENTS

### SUMMARY OF THE INVENTION

The present disclosure is directed at systems, apparatus and methods for implementing a multichannel authoring and content management system.

In one aspect, the present disclosure is directed at a content management system for facilitating storage and retrieval of content for use in creating new content. The content management system can comprise a type dictionary storing a plurality of element types and a plurality of layout types, wherein each layout type is associated with at least some of the plurality of element types. The content management system can also comprise a content editor in communication with the type dictionary, the content editor configured to generate, based on input received from a user, a document associated with a layout type of the plurality of layout types, wherein the document comprises a plurality of elements, and wherein each element of the plurality of elements is associated with an element type of the plurality of element types. The content management system can further comprise a database configured to store the layout type associated with the document, the plurality of elements, and the element type associated with each of the plurality of elements The content management system can also comprise a content retrieval interface configured to receive user input indicating an element that the user desires to retrieve, and to retrieve the specified element.

In some embodiments, the database of the content management system can be configured to store each element of the plurality of elements in a plurality of digital formats.

In some embodiments, the plurality of digital formats include at least one of HTML2, HTML3, HTML4, HTML5, TEXT, PDF, JSON, XML, JPG, PNG, and GIF formats.

In some embodiments, the content retrieval interface can be further configured to receive user input indicating a desired format for the element that a user desires to retrieve; to determine whether the desired format for the element is available; when the desired format is available, to retrieve the element in the desired format; and when the desired format is not available, to determine a closest-available format in which the element is available, and to retrieve the element in the closest-available format.

In some embodiments, the content retrieval interface can also be configured, when the desired format is not available, to translate content comprising a closest-available format for the element into the desired format.

In some embodiments, the plurality of element types can include at least one of price, title, description, date, image, heading, button, link, logo, and custom.

In some embodiments, the plurality of layout types can include at least one of coupon, article, webpage, survey, newsletter, event, sweepstakes, sign-up forms, tweet, Facebook post, email, and print ad.

In another aspect, the present disclosure is directed at a content management system for facilitating storage and retrieval of content for use in creating new content. The content management system can comprise a type dictionary storing a plurality of element types and a plurality of layout types, wherein each layout type is associated with at least some of the plurality of element types. The content management system can further comprise a content editor in communication with the type dictionary, the content editor configured to receive user input selecting a layout type of the plurality of layout types; determine, based on the type dictionary, element types associated with the selected layout type; receive a plurality of elements; associate each element of the plurality of elements with one of the element types associated with the selected layout type; and store in a database the selected layout type, the received plurality of elements, and metadata associating each element of the plurality of elements with its associated element type.

In yet another aspect, the present disclosure is directed at a computer-implemented method of facilitating storage and retrieval of content for use in creating new content. The method can comprise providing, at one or more computer processors, a type dictionary storing a plurality of element types and a plurality of layout types, wherein each layout type is associated with at least some of the plurality of element types. The method can further comprise receiving, at the one or more computer processors, user input selecting a layout type of the plurality of layout types; and determining, at the one or more computer processors, based on the type dictionary, element types associated with the selected layout type. The method can also comprise receiving, at the one or more computer processors, a plurality of elements; associating, at the one or more computer processors, each element of the plurality of elements with one of the element types associated with the selected layout type; and storing, in a database coupled to the one or more computer processors, the selected layout type, the received plurality of elements, and metadata associating each element of the plurality of elements with its associated element type.

In some embodiments, the storing step can further comprise storing in the database each element of the plurality of elements in a plurality of digital formats.

In some embodiments, the plurality of digital formats include at least one of HTML2, HTML3, HTML4, HTML5, TEXT, PDF, JSON, XML, JPG, PNG, and GIF formats.

In some embodiments, the method can further comprise receiving user input indicating an element that a user desires to retrieve, and a desired format for the element that the user desires to retrieve; determining whether the desired format for the element is available; when the desired format is available, retrieving the element in the desired format; and when the desired format is not available, determining a closest-available format in which the element is available, and retrieving the element in the closest-available format.

In some embodiments, the method can further comprise translating, when the desired format is not available, content comprising a closest-available format for the element into the desired format.

In some embodiments, the plurality of element types include at least one of price, title, description, date, image, heading, button, link, logo, and custom.

### Overview

The presently disclosed systems, methods and apparatus relate to content management systems that facilitate the process of repackaging old content into new content. The disclosed embodiments facilitate this process by adding metadata to content that distinguishes discrete elements within the content. For example, a single piece of content (e.g., a document) can contain multiple discrete elements, such as a title, a description, a price, an image, and a date. Using the techniques described herein, the disclosed embodiments can add metadata to the content that separately labels and distinguishes between each individual element. The disclosed embodiments can do so either by (i) using an integrated editor that, through the process of creating a new piece of content, can automatically add the before-mentioned metadata to different elements, or (ii) analyzing content created using other editors and inferring, using rules-based heuristics and algorithms, the appropriate metadata to add to each element in the analyzed content. The presently disclosed embodiments can also save each element within a piece of content in multiple redundant formats. These formats can include, without limitation, HTML2, HTML3, HTML4, HTML5, TEXT, PDF, JSON, XML, JPG, PNG, GIF, or other digital formats. Alternatively, the presently disclosed embodiments can save each element in only one format, but then include modules for translating that format into multiple redundant formats when the element is subsequently retrieved at a later time.

By keeping track of metadata that distinguishes elements within content, and also by saving content in multiple redundant formats (or translating content at the time of retrieval), the presently disclosed content management systems can facilitate the process of repackaging old content into new content. For example, when an organization wishes to repackage a PDF document designed for a physical mail campaign into a HTML webpage designed for a banner ad, there would be no need for a human operator to examine the old piece of content, manually distinguish between each individual element of the PDF document (e.g., the title, the description, the price, the image, and the date), and then copy only the elements that apply into the HTML webpage. Furthermore, there would be no need for a human operator to convert images and text from PDF format into a format suitable for a HTML webpage. Since the elements within the previous document have already been distinguished using metadata, and since each element has been saved into multiple redundant formats, it would be easy to retrieve only the required elements in a convenient format for use in a new piece of content. For example, this retrieval process can be facilitated by automated computer processes, with minimal input from a human operator.

One of the goals of the presently disclosed methods, systems and apparatus is to facilitate repackaging of previously authored and/or published content into new content. This repackaging process can comprise converting content adapted for one delivery channel (e.g., a flyer for print advertising in a newspaper) into another delivery channel (e.g., an ad for sending via an email campaign). Different delivery channels can have different capabilities for presenting content to end consumers. For example, digital delivery channels such as email and webpages can present content to end consumers by transmitting it via a data network, and displaying the content to end consumers on an electronic screen. On the other hand, printed delivery channels such as magazines, newspapers or postcards present content to end consumers via words, images and/or patterns printed on some physical media, such as paper or cardboard. Even digital delivery channels can have different capabilities for presenting content. For example, content delivered via SMS is delivered to users' mobile phones via a cellular network, while content delivered via the Internet is transmitted through a data network and presented to consumers via a web browser or email program. Content delivered via a Facebook feed or twitter account can appear as push notifications on users' mobile devices, while content delivered via webpages cannot.

The repackaging process can also comprise repackaging content to use in the same delivery channel as before, but with certain key details changed (e.g., changing the date and/or price of a previous promotional offer). In some embodiments, the repackaging process can also comprise changing the digital format of previously authored and/or published content (e.g., changing from a HTML format into a PDF format).

Another goal of the presently disclosed methods, systems and apparatus is to increase the extent to which this repackaging process can be performed by automatic computer processes without human intervention. Increasing the extent to which the repackaging process can be performed by computers rather than human operators can be an important factor for managing large amounts of content that needs to be repackaged into new content. In some embodiments, this repackaging process can be performed completely by computers, without requiring any input from a human operator beyond an instruction to begin.

Yet another goal of the presently disclosed methods, systems and apparatus is to introduce a process of authoring or creating new content such that standard elements of the content (e.g., title, description, price, date, image) are separately identified with metadata for easy retrieval later on.

Yet another goal of the presently disclosed methods, systems and apparatus is to facilitate the saving of content into multiple different digital formats, also for easy retrieval during the repackaging process.

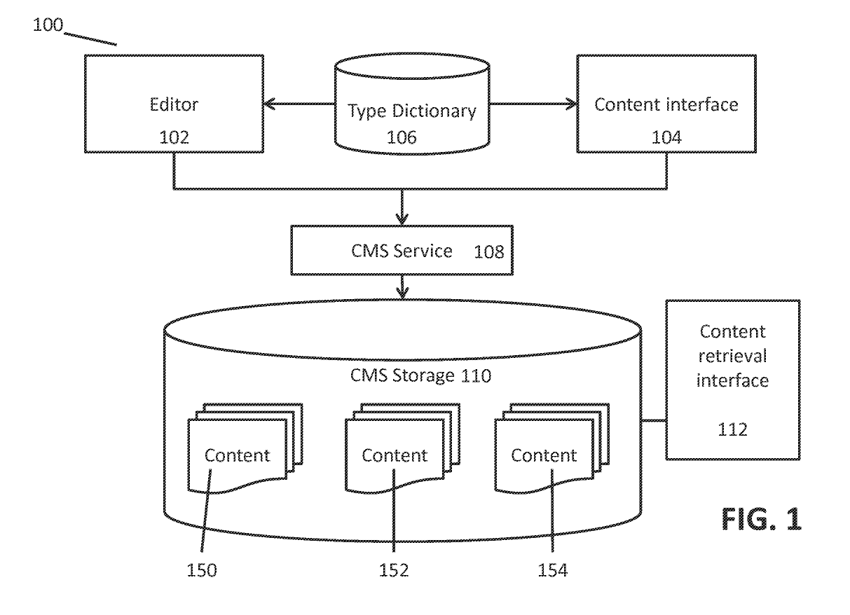

FIG. 1 is a system block diagram illustrating the components of a content management system 100, according to some embodiments. Content management system 100 can comprise editor 102, type dictionary 106, content interface 104, CMS service 108, content retrieval interface 112, and CMS storage 110. CMS storage 110 can store content, e.g., Content 150, Content 152, and Content 154, into multiple different formats.

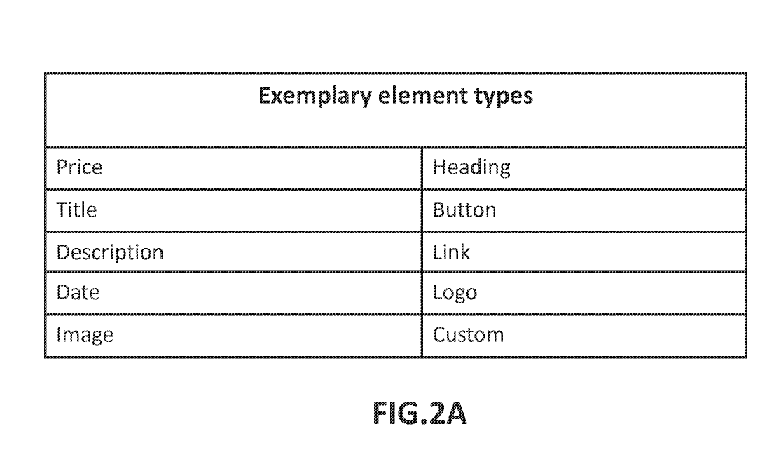

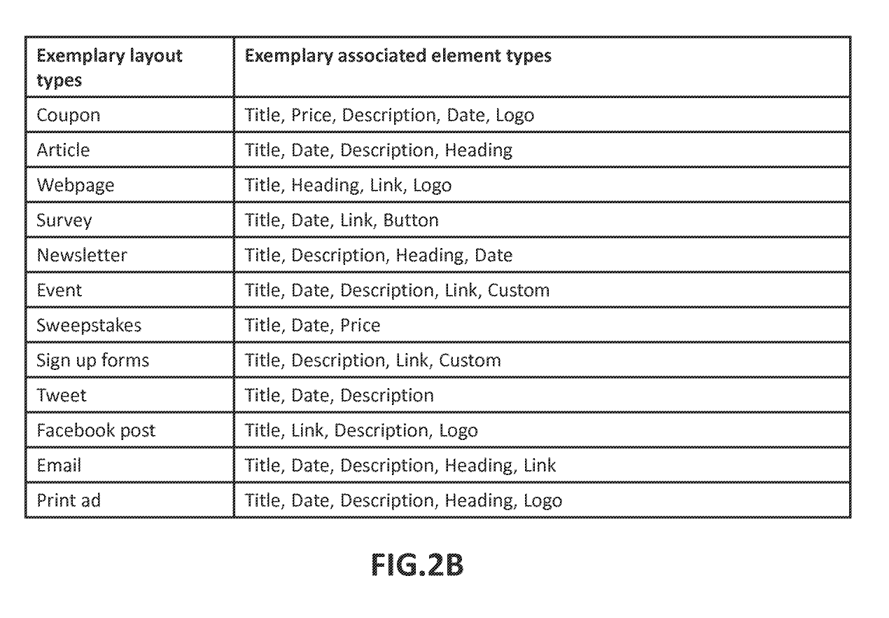

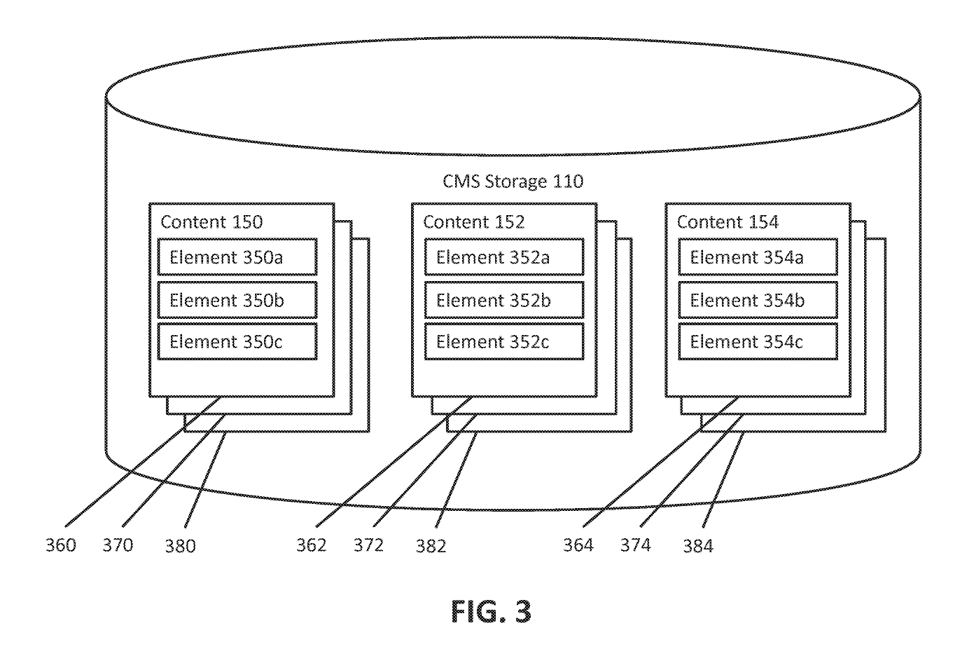

In some embodiments, there can be two ways in which content can be saved into content management system 100. The first way is via editor 102. Editor 102, as described in further detail below with reference to FIG. 3, can be an application residing on a user's device (e.g., desktop computer, portable computer, or mobile device) that enables the user to design and create new content. Editor 102, in conjunction with type dictionary 106, can guide the user to create content such that the content is automatically tagged with identifying metadata to facilitate easy organization and retrieval later on. For example, content created using editor 102 can be automatically identified according to a layout type (e.g., coupon, flyer, email ad, etc.), and elements of the content can be automatically tagged with metadata indicating an element type (e.g., title, description, date, price, image, etc.). The process of creating new content using editor 102 is explained in greater detail below in relation to FIGS. 2A, 2B, 3 and 4.

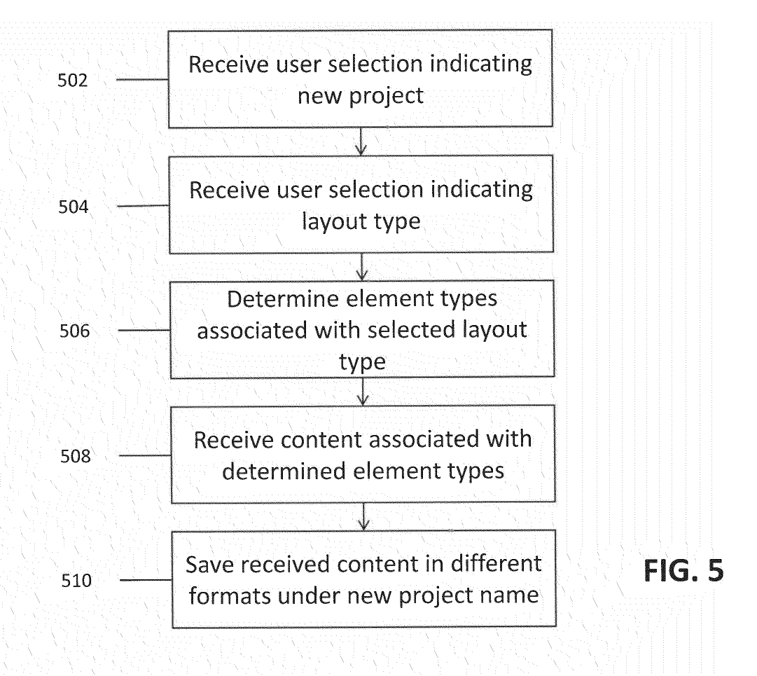

The other way in which content can be saved into content management system 100 is via content interface 104. Content interface 104 can also be an application that resides on a user's device. Content interface 104 can enable a user to upload content that had been created using an authoring tool that is different from editor 102. Such authoring tools can include, for example, Microsoft Word, Adobe Illustrator, Adobe Photoshop, Microsoft Publisher, and Adobe Digital Publishing Suite. Because such content had not been created using editor 102, the content will not be tagged with the identifying metadata created by editor 102. Content interface 104 can interface with type dictionary 106 in order to intelligently infer such metadata. The process of inferring metadata from uploaded content is also explained in greater detail below in relation to FIG. 5.

Type dictionary 106 can be a database containing a list of allowed “element types” and a list of allowed “layout types.” An exemplary, non-exhaustive list of element types are presented in FIG. 2A. Element types can be different types of components that are commonly seen in content stored in content management system 100. For example, permissible element types can include “price,” “title”, “description”, “date” and “image,” all of which can commonly appear in, for example, advertising publications and promotional coupons. Permissible element types can also include elements that commonly appear in web publications, social media, or emails, such as “links” (e.g., hyperlinks) and “buttons” (e.g., radio buttons for surveys). In some instances, type dictionary 106 can contain a “custom” element type which can be defined and customized by users, system administrators, and/or customers to suit their needs. In some embodiments, each of these element types can be broken out into multiple element types, or into sub-element types arranged hierarchically below a single element type. For instance, the element type “Heading” can be broken down into “sub-heading”, “side-heading”, or “side-article heading”, etc. Similarly, the element type “image” can be broken down into “sub-image”, “side image”, “horizontal image”, “vertical image”, etc.

An exemplary, non-exhaustive list of layout types are presented in FIG. 2B. Layout types can be different types of documents that are stored in content management system 100. In the context of an advertising or publishing agency, these layout types can include, for example, “coupons,” “articles”, “webpages”, “email”, etc. These layout types can include both print-only publications (e.g., “print ad”), web-only publications (e.g., “email”, “webpage”, “facebook post”, “tweet”), as well as publications that can be either printed or published digitally (e.g., “article”, “survey”, “newsletter”). In addition to storing a list of permissible element types and layout types, type dictionary 106 can also store exemplary associations between element types and layout types. These associations can represent the element types that are generally seen in certain layout types, and can be configurable by a user or a system administrator. For example, an “article” commonly contains a “title,” a “date”, a “heading”, and a “description,” so type dictionary 106 can store an association between the layout type “article” and those four element types. On the other hand, a “coupon” generally contains a “title,” a “date”, a “description”, a “price” as well as a “logo.” Therefore, type dictionary 106 can store an association between the layout type “coupon” and those five element types. Type dictionary 106 can reside on the same device or on a different device than editor 102 and content interface 104. In some embodiments, type dictionary 106 can be coupled to editor 102 and/or content interface 104 via a physical, wired link (if in the same device), via a local network (e.g., LAN network, either wired or wireless), or via a remote network link (e.g., the Internet, either via a wired network or wireless). In addition to the examples listed above, many different types of layout types, element types, and associations between layout types and element types are also possible. Content management system 100 can be extended to incorporate these additional layout types and element types.

In some embodiments, some of the elements listed in FIG. 2B as a “layout type” can also be configured as an “element type.” For instance, a “coupon” can be considered an element within a document of layout type “newsletter”, for a newsletter may have one, two, or more coupons attached for end consumers to cut out and use. Similarly, an “event” can be an element within a document of layout type “Facebook post” or “Web page,” and an “article” can be an element within a document of layout type “newsletter.”

Returning to FIG. 1, content and metadata from editor 102 and/or content interface 104 can be passed to CMS service 108, which is a remotely accessible code unit which receives the content and metadata, and stores it in CMS storage 110. CMS service 108 can be an application that resides on the same device or on a different device as editor 102 and/or content interface 104. In some embodiments, CMS service 108 can reside on the same device as CMS storage 110, or on a different device. In different embodiments, CMS service 108 can also be coupled to other components via a physical link, a local network link, or a remote network link.

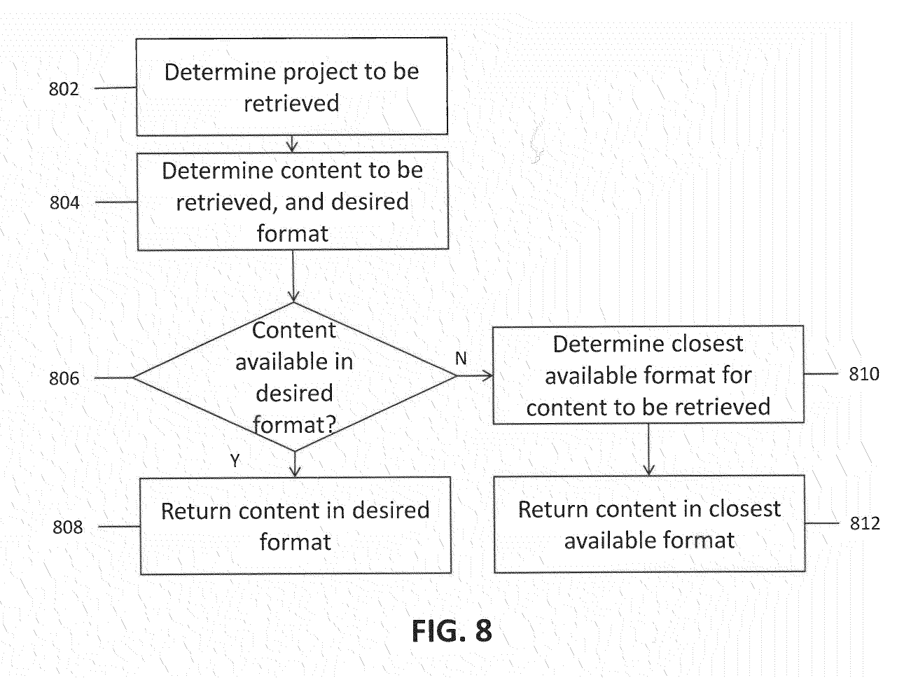

CMS storage 110 can be any conventional database for storing content. Content saved by CMS service 108 into CMS storage 110 can be stored in multiple redundant formats. For example, if content received by CMS service 108 from editor 102 and/or content interface 104 is in one format only (e.g., PDF), CMS service 108 can automatically convert that content into multiple different formats, or the editors 102 can provide the different formats directly e.g., HTML, raw text, raw images, etc. CMS service 108 can then store that content, e.g., Content 150, Content 152, and Content 154, in all of its different, redundant formats, into CMS storage 110. Content retrieval interface 112 can be configured to allow a user to retrieve content stored in CMS storage 110. The process for retrieving content is explained in greater detail below in relation to FIG. 8.

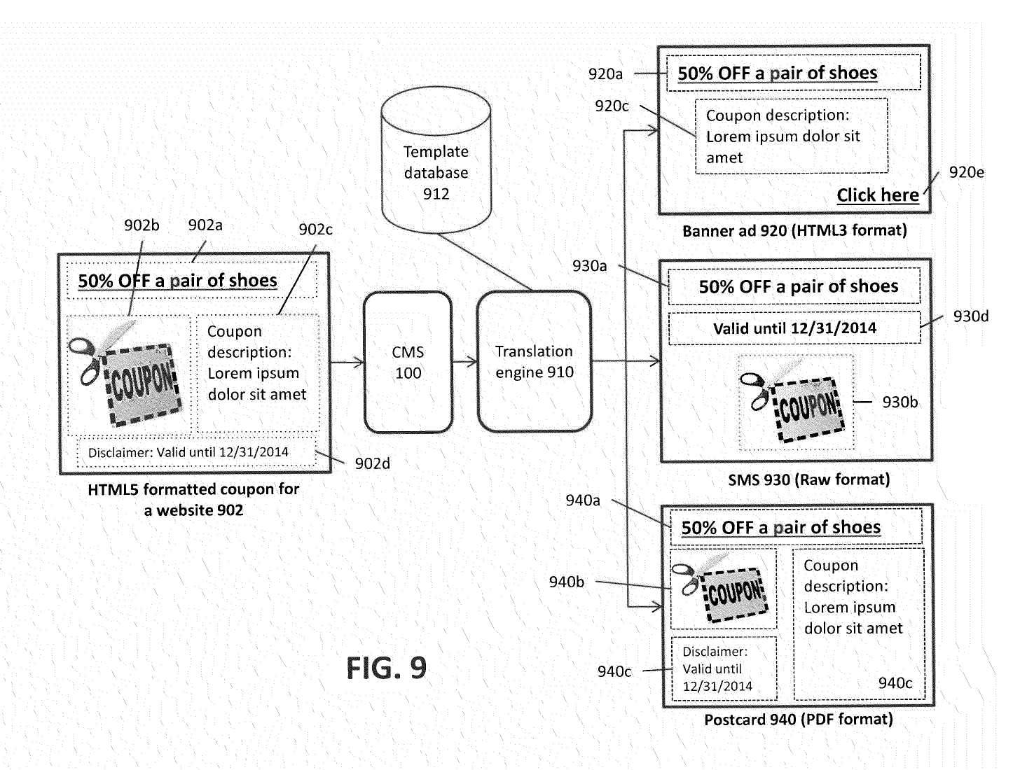

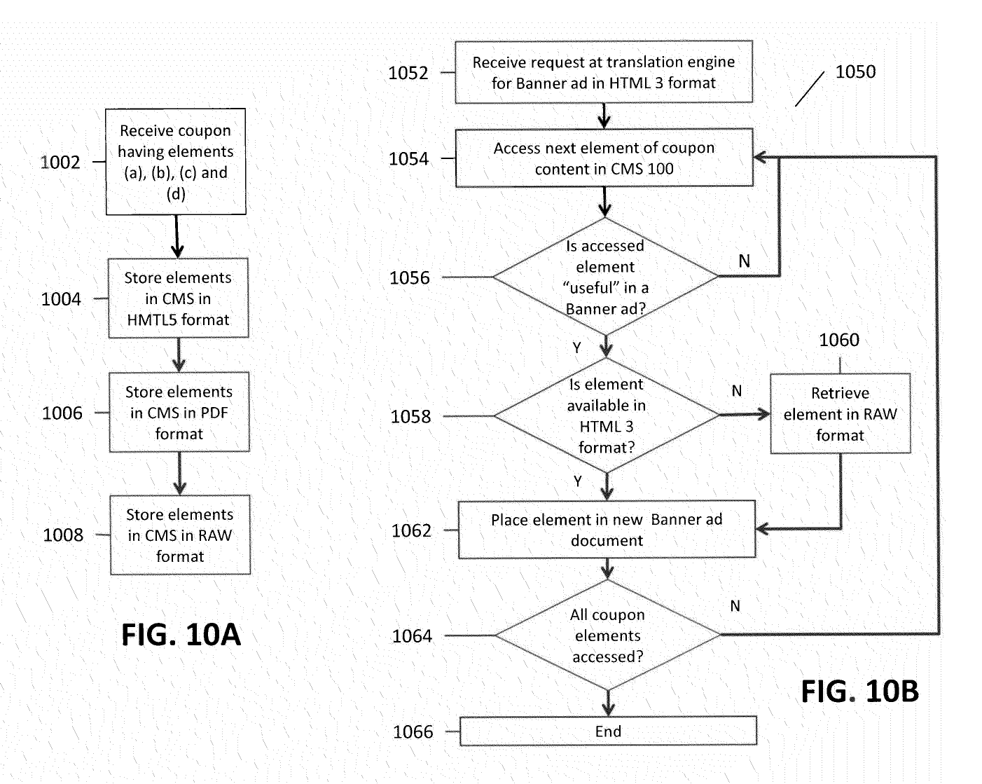

In some embodiments, CMS 100 can also include a translation engine (not shown FIG. 1) for receiving content elements from content retrieval interface 112, and for repackaging the received content elements into new content. This translation engine can be an integral part of CMS 100, or it can be a separate component coupled to CMS 100 via an internal bus or over a network link. In some embodiments, the translation engine may be programmed, provided and/or implemented on a hardware device maintained by a different business entity than a business entity maintaining CMS 100; in other embodiments, the translation engine and CMS 100 may be programmed, provided and/or implemented by the same business entity. The translation engine is discussed in further detail below in relation to FIGS. 9 and 10.

FIG. 3 is an conceptual block diagram that illustrates CMS storage 110 and its contents in greater detail, according to some embodiments. As described above, CMS storage 110 can be any conventional database that stores content, such as for example, content 150, content 152, and content 154. Each piece of content can be separately labeled with metadata indicating its layout type. Each piece of content (e.g., a document, such as an article, a coupon, a webpage, an email), can include multiple elements. For example, content 150 can contain elements 350a, 350b and 350c; content 152 can contain elements 352a, 352b, and 352c; and content 154 can contain elements 354a, 354b, and 354c. Each element can be separately labeled with metadata identifying its element type. In addition, each piece of content can be saved in multiple redundant digital formats to facilitate ease of retrieval. Content 150, including each of its elements 350a, 350b and 350c, can be saved in a first format 360, a second format 370, and a third format 380. Similarly, content 152, including each of its elements 352a, 352b and 352c can be saved in a first format 362, a second format 372, and a third format 382. Content 154 can also be saved in different formats in the same way. The formats in which contents 150, 152 and 154 (including their respective elements) can be saved can be the same across all content saved in CMS Storage 110, or different.

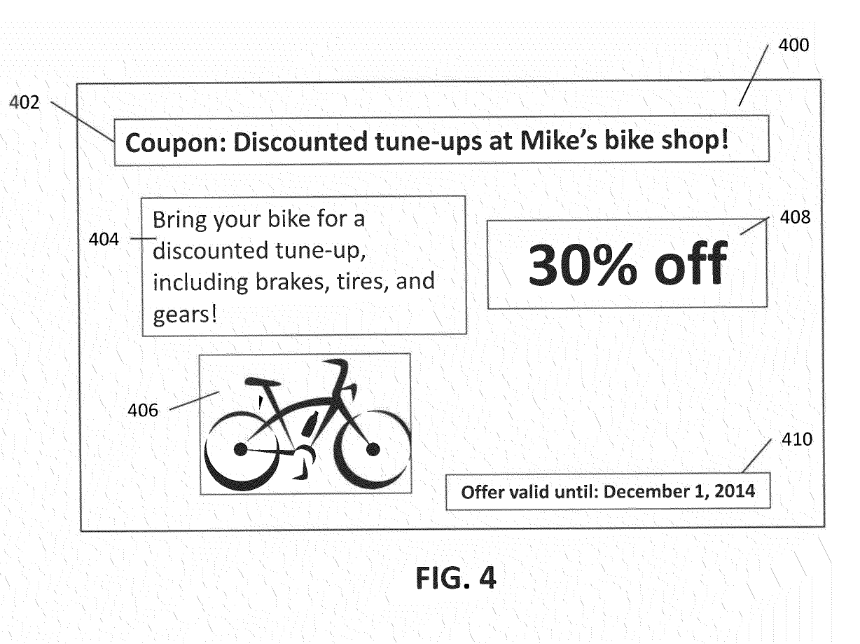

FIG. 4 is an exemplary document 400 of the layout type “coupon”, which contains exemplary elements title 402, description 404, image 406, price 408, and date 410. Title 402 can be the title or main description of the document 400, which in this instance, is an element identifying the document as a “coupon” that entitles the holder to “discounted tune-ups at Mike's bike shop.” Description 404 can be a text element that provides more details regarding the coupon, for example, “Bring your bike for a discounted tune-up, including brakes, tires, and gears!” For different coupons or different layout types, the description 404 can be different. Image 406 can be an appropriate image that adds visual appeal to the document 400. Price 408 can be text that provides details regarding the dollar or percentage value of the coupon. In this example, price 408 indicates that the coupon entitles its holder to 30% off the market value of a tune-up session. For different coupons or for different layout types, the content “price” can signify different things. For example, the “price” might indicate the dollar price of an item, or the number of dollars off for a sale promotion. In some embodiments, the element type “price” can be further differentiated into different types of content, e.g., “price in dollars,” “dollars off”, or “percent off”. Finally, date 410 can be a text element that indicates a date that is significant to the document 400. In this example, date 410 indicates that the coupon is valid until Dec. 1, 2014. The date 410 can include other kinds of dates depending on the coupon and the layout type. For example, the date 410 can include the date on which the coupon was published, and not the date on which the coupon will expire, in certain contexts. In some embodiments, the element type “date” can be further differentiated into different types of dates, e.g., “valid-until date” or “publication date.”

FIG. 5 is a flowchart illustrating an exemplary process for creating new content (e.g., document 400) using editor 102. At step 502, editor 102 can receive user input indicating that the user desires to begin a new project. At step 504, editor 102 can receive user input selecting the layout type of the new project. At this step, for example, editor 102 can receive user input indicating that the user wants the new project to be a coupon, an article, a webpage, or an email ad. At step 506, editor 102 can determine the element types that are associated with the selected layout type. This step can comprise communicating with type dictionary 106 to retrieve the element types associated with the user's selected layout type. For example, if the user had selected that the new project should be of layout type “coupon”, editor 102 can determine, in conjunction with type dictionary 106, that the element types associated with this layout type include a “title”, “description”, “image”, “price” and “date.”

At step 508, editor 102 can receive content associated with at least some of the determined element types. In some embodiments, editor 102 can operate similarly to other authoring tools: a user can be presented with a blank canvas on which the user can add textboxes, images, backgrounds, and other items. The difference between editor 102 and other authoring tools is that instead of simply adding a generic textbox, a user can, for example, instruct editor 102 to add a “title” textbox, a “description” textbox, a “price” textbox and/or a “date” textbox. User can drag and drop these textboxes onto the appropriate part of the blank canvas, and resize or format said textboxes according to conventionally known methods. Users can also add images or other elements using similar methods. Any content that the user puts into these boxes can then be identified with the corresponding metadata identifying the element type. For example, any text that the user puts into a “title” textbox can be identified using metadata as belonging to the element type “title”; any text that the user puts into the “price” textbox can be identified using metadata as belonging to the element type “price.” In other embodiments, if the user has selected that this project should be of layout type “coupon,” editor 102 can present user with a pre-formatted coupon template, with blank, pre-arranged, pre-formatted fields for “title,” “price”, “description”, “date” and “image.” In some embodiments, these pre-arranged, pre-formatted fields can have default sizes, positions, fonts, color, and other formatting options, but some or all of these options can be customized by the user.

While editor 102 can present the user with default options for element types associated with the layout type that the user had selected, the user can also, in some embodiments, add additional element types not associated with the selected layout type. For example, if the user is creating an article in editor 102, editor 102 may present to the user a set of default element types to populate, such as “title,” “date” and “description.” If, however, the user would like to add an “image,” the user can also add such an element type, even though this element type is not associated with the layout type “article.”

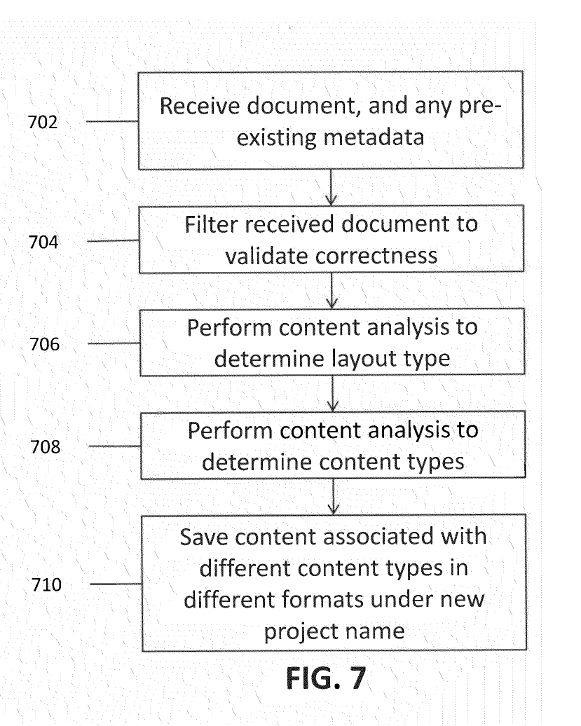

At step 510, the content and metadata can be stored under different formats into CMS storage 110 by CMS service 108. As described above, even if the content was originally provided in a certain format (e.g., if the image provided was a JPG only), CMS service 108 can convert the content into other formats (e.g., GIF, or TIFF) and save those other formats, along with the received format, into CMS storage 110. In some embodiments, CMS service 108 can automatically, without prompting from the user, save content into different formats, wherein the set of different formats is configurable. In other embodiments, CMS service 108 can prompt the user to identify the formats in which the user would like to save the content. As described later in more detail with regard to FIG. 7, saving content in multiple different formats can facilitate the process of retrieving content for use in repackaging and creating new content. All these different formats can be saved under the name of the new project.

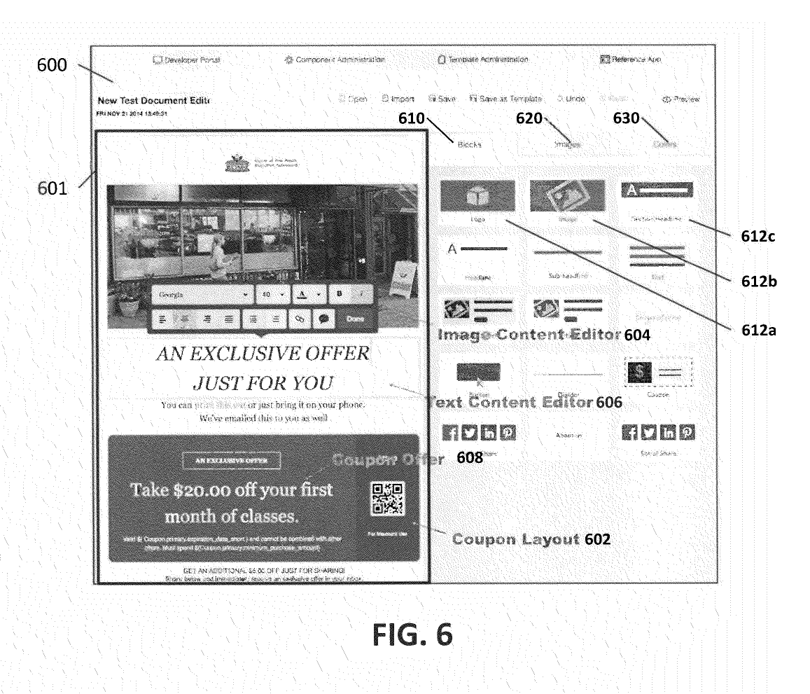

FIG. 6 is an exemplary screenshot 600 of an editor 102, according to some embodiments. Screenshot 600 includes an editing window 601, which displays a document on which the user is currently working, and which gives the user various options and tools for creating and editing content. In this case, editing window 601 is currently displaying a document 602 of layout type “coupon.” Document 602 includes an element 608. In this example, element 608 is of element type “offer,” but other element types are also possible, such as “Title”, “Description” or “Heading.” Editing window 601 also includes a text content editor 606 which, in some embodiments, can be automatically invoked by a user by clicking on any text element. Text content editor 606 allows the user to change the font, font size, font color, and other formatting options (e.g., bold/italics/underline, left/middle/right/justified alignment, etc.). Editing window 601 also includes an image content editor 604. Although not depicted in detail in FIG. 6, image content editor 604 can be used to adjust various image parameters of discrete images or sets of images in document 602, such as color, contrast, brightness, size, and orientation.

Screenshot 600 further includes Blocks tab 610, Images tab 620, and Colors tab 630. Blocks tab 610 includes various selectable icons which correspond to different element types. For instance, icon 612a allows the user to create a new element of type “Logo.” Icon 612b allows the user to create a new element of type “Image”. And Icon 612c allows the user to create a new element of type “Section Headline.” When the user selects such an icon, a new element of the selected element type can appear within editing window 601. The user can then edit the contents and parameters of that element using the text content editor 606 and the image content editor 604. Alternatively, when the user selects such an icon, the user can drag and drop the new element into editing window 601, or the user can outline a shape within editing window 601 within which the new element should appear. Any element created using the icons 612a-c in blocks tab 610 can be tagged with metadata including the appropriate element type. This metadata tagging can be performed automatically by editor 102, without any additional user intervention, such that different elements within document 602 can be automatically labeled and differentiated to facilitate more targeted retrieval later on. When the user selects images tab 620, the user can access a library of images and image-editing options for inclusion within document 602. When the user selects colors tab 630, the user can change the color scheme of document 602, such as changing the background color, changing the color of text and lines, etc.

FIG. 7 is a flowchart illustrating an exemplary process for analyzing and inferring layout types and element types for content received via content interface 104. As discussed earlier, content received via content interface 104 can be created by authoring applications other than editor 102; such content generally does not contain metadata describing layout type or element type. Rather, the layout types and element types must be inferred by content interface 104 in conjunction with type dictionary 106. At step 702, content, as well as any pre-existing metadata, can be received by content interface 104. At step 704, content interface 104 can perform a filter check to validate the correctness of incoming content. This filter can be a stream based analysis system that validates the syntactical correctness of data. For example, the filter can verify whether text identified by any metadata really is text. Alternatively or additionally, the filter can compare any provided metadata against the list of allowable element types and layout types in type dictionary 106. At step 706, content interface 104 can perform content analysis to determine the layout type of the content. For example, if the received content contains the phrase “10% off everything until Mar. 3, 2016”, the content interface 104 can infer, according to a set of predetermined rules and heuristics, that the received content is a coupon. Content interface 104 can then add metadata identifying the received content as belonging to the layout type “coupon.”

At step 708, content interface 104 can perform content analysis to determine different element types. For example, when content interface 104 is processing text elements, content interface 104 can look for keywords like “coupon” or “offer” or “% off” to determine that the provided content is a coupon. Semantic analysis can then distinguish between the title and the body of a coupon. Content interface 104 can also differentiate between text and images, such that text elements are identified with text element types (e.g., title, date, price, description, etc.), and image elements are identified with image element types (e.g., image, logo, etc.).

At step 710, content interface 104 can pass the received content as well as received and/or inferred metadata to CMS service 108, which in turn saves the content and metadata into CMS storage 110 under different formats. As described above, CMS service 108 can save the content under multiple different formats. Also as described above, this process can be automatic and/or configurable by the user according to different embodiments.

FIG. 8 is a flowchart illustrating an exemplary process for retrieving content saved by content management system 100 using content retrieval interface 112, according to some embodiments. At step 802, content retrieval interface 112 can receive input from a user indicating the project to be retrieved. At step 804, content retrieval interface 112 can receive input from a user indicating what content within that project is to be retrieved, as well as the desired format of that content. For example, a user may wish to re-use the images from a previous coupon when designing a new coupon, but has no need for the previous coupon's title, description, price, or date. The user also requires that the image be in the HTML format. This may be because the medium in which this new coupon needs to be transmitted in (e.g., email) only accepts HTML format images. Under this example, content retrieval interface 112 would then receive input from the user identifying the previous coupon project, and then receive input from the user indicating that the user would like to access all content of element type “image” from that previous coupon project, as well as to receive content in the HTML format.

At step 806, content retrieval interface 112 performs a search of CMS storage 110 to determine whether the requested content is available. To continue the example above, content retrieval interface 112 determines whether CMS storage 110 contains images from the indicated coupon project that are in HTML format. If the answer is “yes,” content retrieval interface 112 branches to step 808 and simply returns the requested content (images) in the desired format (HTML). If the answer is “no,” content retrieval interface 112 branches to step 810 and determines the closest available format for the requested content. For example, if no HTML images are available, content retrieval interface 112 can then check whether the requested content is available in PDF format. If PDF format is not available, content retrieval interface 112 can check whether the requested content is available in JPG format. Content retrieval interface 112 can fall back to more and more primitive formats until it finds a format that is available in CMS storage 110. Once an available format is found, content retrieval interface 112 returns the content in the closest available format at step 812. Many different ways of prioritizing formats are also possible. In some embodiments, the priority of different formats can be specified by the user at the time of retrieval, or it can be pre-configured by the user, by a programmer, or a system administrator. In other embodiments, content retrieval interface 112 can simply inform the user that a requested format is not available, then offer the user a choice between a list of available formats.

In yet other embodiments, content retrieval interface 112 can also evaluate whether it has the capability of translating the closest-available stored format into the format requested by the user using automatic computer translation tools. If content retrieval interface 112 determines that it has this capability, it can either prompt the user if it wishes to translate from the closest-available format to the requested format, or simply automatically perform the translation step and present the content in the requested format. In some of these embodiments, instead of performing this translation step itself, content retrieval interface 112 can be configured to register different format translators to perform translation on its behalf. These format translators can be stand-alone applications separate from content retrieval interface 112 that can translate content in one format into another format. In some cases, format translators can be provided and/or maintained by third-party providers (e.g., by business entities separate from either the user or the entity maintaining or providing content management system 100). Content retrieval interface 112 can maintain a database of available format translators. When content retrieval interface 112 determines that translation is necessary, it can identify the correct format translator and pass the content to be translated to that format translator for translation. Content retrieval interface 112 can be configured to communicate with such format translators using a REST/JSON interface.

Although the systems, apparatus and methods above can save content into CMS storage 110 in multiple different formats to facilitate retrieval later on, other embodiments are also possible. According to some embodiments, rather than saving content in multiple formats, content management system 100 could save only one format into CMS storage 110, but implement an automatic translation process into multiple formats (or only the requested format) when a user desires to retrieve content in a particular format. For example, rather than saving a PDF image also as a HTML, and JPG image, content management system 100 could save only the PDF image. When a user desires to retrieve that image in HTML format, content management system 100 could execute a translation step at the time of retrieval to automatically translate the requested image into the requested format. While this embodiment can result in slower retrieval times due to the necessity of translating content into alternate formats, this embodiment can also require less storage space for CMS storage 110.

The presently disclosed systems, apparatus and methods can facilitate automated, or semi-automated, content repackaging in at least two ways. First, by separately tagging elements within documents with metadata indicating element types, content management system 100 enables users to request specific elements in previously authored documents. If content is created using editor 102, the tagging occurs automatically as part of the content creation process, as described above. If content is uploaded via content interface 104, the tagging can be done via a process that infers layout types and element types based on an analysis of the content. The tagging of elements with element type metadata saves the user from having to pull up the entire document, and then manually identifying which part of the document corresponds to the desired element, e.g., the title, the image, or the price. Second, by either saving content in multiple redundant formats, or by translating stored content at the time of retrieval, content management system 100 can present the retrieved content in a digital format most useful to the user. The user can then quickly and easily copy the retrieved content into new documents.

FIG. 9 is an exemplary logical diagram that illustrates how a previously authored document (e.g., a HTML5 formatted website coupon 902) stored in content management system 100 can be automatically repackaged into new content adapted for different delivery channels (e.g., website banner ad 920, SMS ad 930, and/or Postcard 940). FIG. 9 includes an HTML 5 formatted website coupon 902 that is initially stored in content management system 100. Coupon 902 is a previously authored document of layout type “coupon.” Coupon 902 can be stored in CMS 100 either through the editor 102 or the content interface 104, as described above. Also as described above, coupon 902 can include multiple elements, such as title 902a, image 902b, description 902c, and date 902d. Each element 902a, b, c, and d can be stored in CMS 100 in multiple formats, such as HTML5, HTML3, PDF, or RAW (e.g., ASCII text, and/or picture formats such as JPG or GIF).

FIG. 9 also includes a translation engine 910 coupled to a template database 912. Translation engine 910 can be configured to request and receive content elements from content retrieval interface 112, and to repackage those content elements into new content. Template database 912 can be configured to store a set of instructions and templates to facilitate this repackaging process. In some instances, new content can be adapted for different delivery channels than the original content. As discussed above, examples of delivery channels include, without limitation, ads in printed publications (e.g., magazines, newspapers), website ads, email ads, printed postcards, social media (e.g., Facebook, Twitter), and/or SMS ads. Translation engine 910 and template database 912 can take advantage of the detailed layout- and element-type metadata associated with documents and content elements stored in CMS 100 to decrease the amount of human intervention required in this repackaging process. In some embodiments, this translation process can be completely automated, and require no human input beyond an initial instruction to begin the translation process. As discussed above, translation engine 910 and/or template database 912 can be an integral part of CMS 100, or it can be a separate component coupled to CMS 100 via an internal bus or over a network link. In some embodiments, the translation engine may be programmed, provided and/or implemented on a hardware device maintained by a different business entity than a business entity maintaining CMS 100; in other embodiments, the translation engine and CMS 100 may be programmed, provided and/or implemented by the same business entity.

In the example provided in FIG. 9, translation engine 910 can be configured to translate website coupon 902 into any one of three types of new content: a website banner ad 920, a SMS ad 930, and a postcard 940. Template dataset 912, which can be any database or memory system known in the art, can store in memory a set of instructions and templates corresponding to each of these new content types. These instructions and templates can include a list of “useful” elements (e.g., what previously-authored elements this new content type can accept), a list of acceptable digital formats (e.g., HTML5, HTML3, PDF, or RAW), as well as instructions regarding how to place and format received elements. While template database 912 can optionally be implemented as an integral part of type dictionary 106, the two components are not to be confused—type dictionary 106 stores layout- and element-types expected to be seen in content stored in CMS 100, whereas template database 912 stores instructions for creating new content using elements from old content.

For instance, if translation engine 910 is directed to translate website coupon 902 into a website banner ad 920, translation engine 910 can access the elements associated with website coupon 902 from CMS 100, then process those elements according to the instructions and templates associated with banner ads stored in template database 912. In this example, the instructions and templates from template database 912 indicate that banner ad 920 accepts only two useful element types: “title” and “description.” The translation engine 910 therefore retrieves only title 902a and description 902c from CMS 100, and not other elements such as image 902b or date 902d. Banner ads also requires elements in HTML3 format, and so translation engine 910 retrieves the HTML3 version of title 902a and description 902c from CMS 100. The instructions and templates associated with banner ads can require that elements of type “title” be placed at the top of the ad, while elements of type “description” be placed immediately below the title. These instructions can also include directions regarding how to format elements, such as whether text should be left-aligned, centered, or right-aligned, the text size, the text color, bold/italics/underline, and other formatting options. Therefore, translation engine 910 places the retrieved elements title 902a and description 902c into the appropriate places on banner ad 920, according to the specified format, to form title 920a and description 920c. Finally, the instructions and templates associated with banner ads may require placement of a link on all such ads, and so translation engine 910 places a link 920e on the bottom right hand corner of the ad.

As a second example, if translation engine 910 is directed to translate website coupon 902 into a SMS ad 930, translation engine 910 can access the elements associated with website coupon 902 from CMS 100, then process those elements according to the instructions and templates associated with SMS ads stored in template database 912. In this example, the instructions and templates from template database 912 indicate that SMS ads only accept three useful element types: “title”, “date” and “image.” The translation engine 910 therefore retrieves only title 902a, image 902b, and date 902d from CMS 100, and not other elements such as description 902c. SMS ads also require elements in RAW format, and so translation engine 910 retrieves the RAW version of title 902a, image 902b, and date 902d. The instructions and templates associated with SMS ads can require that elements of type “title” be placed at the top and be center-aligned, that elements of type “date” be placed directly under the title, and also be center-aligned and bolded, and that elements of type “image” be placed directly under the date. Therefore, translation engine 910 places the retrieved elements title 902a, image 902b, and date 902d into the appropriate places on SMS ad 930, according to the specified format, to form title 930a, date 930d, and image 930b.

As a third example, if translation engine 910 is directed to translate website coupon 902 into a postcard ad 940, translation engine 910 can access the elements associated with website coupon 902 from CMS 100, then process those elements according to instructions and templates associated with postcard ads stored in template database 912. In this example, the instructions and templates from template database 912 indicate that postcard ads accept four useful element types: “title,” “image,” “description,” and “date.” The translation engine 910 therefore retrieves all four elements of coupon 902 from CMS 100, i.e., title 902a, image 902b, description 902c, and date 902d. Postcard ads also require elements in PDF format, and so translation engine 910 retrieves the PDF versions of title 902a, image 902b, description 902c, and date 902d. If PDF versions of any of these elements are not available, translation engine 910 can be configured to request and receive alternative formats, such as RAW format. The instructions associated with postcard ads can require that elements of type “title” be placed at the top and be left-aligned, that elements of type “image” be placed immediately below and to the left of the title, that elements of type “date” be placed immediately below the image, and that elements of type “description” be placed immediately below and to the right of the title. Therefore, translation engine 910 places the retrieved elements 902a, image 902b, description 902c, and date 902d into the appropriate places on Postcard 940.

FIGS. 10A and 10B are flowcharts depicting exemplary processes for saving content into CMS 100, and for repackaging the saved content into new content (e.g., a banner ad in HTML3 format), respectively, in accordance with some embodiments. FIG. 10A shows an exemplary process for saving a coupon into CMS 100, according to some embodiments. At step 1002, the CMS 100 receives a coupon having elements (a), (b), (c) and (d), wherein each element is associated with an element type. This coupon can be received via editor 102 and/or content interface 104, as described above. At step 1004, CMS 100 stores each of the elements associated with the coupon in HTML5 format. At step 1006, CMS 100 stores each of the elements associated with the coupon in PDF format. At step 1008, CMS 100 stores each of the elements in RAW format. Other types of formats can also be stored in CMS 100.

FIG. 10B shows an exemplary process 1050 for repackaging the saved elements into a new content, such as a banner ad in HTML3 format. Process 1050 can be implemented at, for example, translation engine 910. At step 1052, translation engine 910 receives a request for a banner ad in HTML3 format. Translation engine 910 can also receive instructions specifying what previous content to translate from (e.g., the coupon received and stored in FIG. 10A). At step 1054, translation engine 910 accesses the first element associated with the coupon saved and stored in FIG. 10A. At step 1056, translation engine 910 determines whether the accessed element is “useful” in a banner ad. Translation engine 910 can do this by determining whether banner ads accept the element type of the accessed coupon element. If the accessed element is not useful in a banner ad, translation engine 910 can branch back to step 1054 to access the next element of the saved coupon. If the accessed element is useful in a banner ad, translation engine 910 branches to step 1058 and considers whether the element is available in the requested format, e.g., HTML3. If the answer is “no,” translation engine 910 branches to step 1060 where it retrieves the element in RAW format, and then proceeds to step 1064. If the answer is “yes,” translation engine 910 proceeds straight to step 1064. Although FIG. 10B depicts checking for only one alternative format (e.g., RAW format) if the requested format is not available, translation engine 910 can also be configured to check for multiple formats (e.g., HTML5 and RAW), as well as other types of formats. At step 1064, translation engine 910 checks whether all elements associated with the coupon saved in FIG. 10A have been accessed. If the answer is “no,” translation engine 910 branches back to step 1054 where it accesses the next element. If the answer is “yes,” translation engine 910 branches to step 1066, where it ends the translation process and presents the finished translated content to the user.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor can receive instructions and data from a read only memory or a random access memory or both. The essential elements of a computer are a processor for executing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Other embodiments are within the following claims.

What is claimed is:

1. A content management system for facilitating storage and retrieval of content for use in creating new content, comprising:
a type dictionary storing a plurality of element types and a plurality of layout types, wherein each layout type is associated with at least some of the plurality of element types;
a content editor in communication with the type dictionary, the content editor configured to generate, based on input received from a user, a document associated with a layout type of the plurality of layout types, wherein the document comprises a plurality of elements, and wherein each element of the plurality of elements is associated with an element type of the plurality of element types;
a database configured to store the layout type associated with the document, the plurality of elements, and the element type associated with each of the plurality of elements; and
a content retrieval interface configured to receive user input indicating an element that the user desires to retrieve, and to retrieve the specified element.

2. The content management system of claim 1, wherein the database is configured to store each element of the plurality of elements in a plurality of digital formats.

3. The content management system of claim 2, wherein the plurality of digital formats include at least one of HTML2, HTML3, HTML4, HTML5, TEXT, PDF, JSON, XML, JPG, PNG, and GIF formats.

4. The content management system of claim 1, wherein the content retrieval interface is further configured to:
receive user input indicating a desired format for the element that a user desires to retrieve;
determine whether the desired format for the element is available;
when the desired format is available, retrieve the element in the desired format; and
when the desired format is not available, determine a closest-available format in which the element is available, and retrieve the element in the closest-available format.

5. The content management system of claim 1, wherein the content retrieval interface is further configured to:
receive user input indicating a desired format for the element that a user desires to retrieve;
determine whether the desired format for the element is available;
when the desired format is available, retrieve the desired format; and
when the desired format is not available, translate content comprising a closest-available format for the element into the desired format.

6. The content management system of claim 1, wherein the plurality of element types include at least one of price, title, description, date, image, heading, button, link, logo, and custom.

7. The content management system of claim 1, wherein the plurality of layout types include at least one of coupon, article, webpage, survey, newsletter, event, sweepstakes, sign-up forms, tweet, Facebook post, email, and print ad.

8. A content management system for facilitating storage and retrieval of content for use in creating new content, comprising:
a type dictionary storing a plurality of element types and a plurality of layout types, wherein each layout type is associated with at least some of the plurality of element types;
a content editor in communication with the type dictionary, the content editor configured to:
receive user input selecting a layout type of the plurality of layout types;
determine, based on the type dictionary, element types associated with the selected layout type;
receive a plurality of elements;
associate each element of the plurality of elements with one of the element types associated with the selected layout type; and
store in a database the selected layout type, the received plurality of elements, and metadata associating each element of the plurality of elements with its associated element type.

9. The content management system of claim 8, wherein the content editor is configured to store in the database each element of the received plurality of elements in a plurality of digital formats.

10. The content management system of claim 9, wherein the plurality of digital formats include at least one of HTML2, HTML3, HTML4, HTML5, TEXT, PDF, JSON, XML, JPG, PNG, and GIF formats.

11. The content management system of claim 8, further comprising a content retrieval interface configured to:
receive user input indicating an element that a user desires to retrieve, and a desired format for the element that the user desires to retrieve;
determine whether the desired format for the element is available;
when the desired format is available, retrieve the element in the desired format; and
when the desired format is not available, determine a closest-available format in which the element is available, and retrieve the element in the closest-available format.

12. The content management system of claim 8, further comprising a content retrieval interface configured to:
receive user input indicating an element that a user desires to retrieve, and a desired format for the element that the user desires to retrieve;
determine whether the desired format for the element is available;
when the desired format is available, retrieve the element in the desired format; and
when the desired format is not available, translate content comprising a closest-available format for the element into the desired format.

13. The content management system of claim 8, wherein the plurality of element types include at least one of price, title, description, date, image, heading, button, link, logo, and custom.

14. The content management system of claim 8, wherein the plurality of layout types include at least one of coupon, article, webpage, survey, newsletter, event, sweepstakes, sign-up forms, tweet, Facebook post, email, and print ad.

15. A computer-implemented method of facilitating storage and retrieval of content for use in creating new content, the method comprising:
providing, at one or more computer processors, a type dictionary storing a plurality of element types and a plurality of layout types, wherein each layout type is associated with at least some of the plurality of element types;
receiving, at the one or more computer processors, user input selecting a layout type of the plurality of layout types;
determining, at the one or more computer processors, based on the type dictionary, element types associated with the selected layout type;
receiving, at the one or more computer processors, a plurality of elements;
associating, at the one or more computer processors, each element of the plurality of elements with one of the element types associated with the selected layout type; and
storing, in a database coupled to the one or more computer processors, the selected layout type, the received plurality of elements, and metadata associating each element of the plurality of elements with its associated element type.

16. The computer-implemented method of claim 15, wherein the storing step further comprises storing in the database each element of the plurality of elements in a plurality of digital formats.

17. The computer-implemented method of claim 16, wherein the plurality of digital formats include at least one of HTML2, HTML3, HTML4, HTML5, TEXT, PDF, JSON, XML, JPG, PNG, and GIF formats.

18. The computer-implemented method of claim 15, further comprising:
receiving user input indicating an element that a user desires to retrieve, and a desired format for the element that the user desires to retrieve;
determining whether the desired format for the element is available;
when the desired format is available, retrieving the element in the desired format; and
when the desired format is not available, determining a closest-available format in which the element is available, and retrieving the element in the closest-available format.

19. The computer-implemented method of claim 15, further comprising:
receiving user input indicating an element that a user desires to retrieve, and a desired format for the element that the user desires to retrieve;
determining whether the desired format for the element is available;
when the desired format is available, retrieving the element in the desired format; and
when the desired format is not available, translating content comprising a closest-available format for the element into the desired format.

20. The computer-implemented method of claim 15, wherein the plurality of element types include at least one of price, title, description, date, image, heading, button, link, logo, and custom.
